(19) United States
(12) Patent Application Publication
(10) Pub. No.: US 2025/0373556 A1
(43) Pub. Date: Dec. 4, 2025

(54) SYSTEMS AND METHODS FOR LATENCY MANAGEMENT

(71) Applicant: Comcast Cable Communications, LLC, Philadelphia, PA (US)

(72) Inventor: Jason LIVINGOOD, Philadelphia, PA (US)

(21) Appl. No.: 18/677,030

(22) Filed: May 29, 2024

(51) Int. Cl. H04L 47/22; H04L 47/11; H04L 69/22

(52) U.S. Cl. CPC H04L 47/22; H04L 47/11; H04L 69/22

(57) ABSTRACT

Methods and systems for latency management are disclosed. A computing device may intermediate between an application that supports a low-latency protocol and an application server that does not support the low-latency protocol. The computing device may read labels associated with the low-latency protocol in the packet headers of network traffic and rate shape the traffic flow between the application and the application server accordingly.

### BACKGROUND

Low-latency protocols may be used to manage network traffic and reduce network latency. Adopting a low-latency protocol may require that both an end-user application and the corresponding application server support the low-latency protocol. However, application developers (e.g., owners, operators) may have no control over whether application servers support the low-latency protocol, as the application servers may be controlled by third-party cloud or hosting providers. These and other shortcomings are addressed by the present disclosure.

### SUMMARY

Methods, systems, and devices for latency management are disclosed. An application developer may want an application to support a protocol. The protocol may mark network traffic (e.g., in packet headers) with either a first label that indicates network congestion, or a second label that indicates a lack of network congestion. A bitrate of the network traffic may be slowed down (e.g., reduced) if the network traffic is marked with the first label, while the bitrate of the network traffic may be sped up (e.g., increased) if the network traffic is marked with the second label. However, the application server may not support the protocol (e.g., cannot read the first or second labels). To ensure that the application can take advantage of the protocol despite the application server not supporting the protocol, a controller device may be employed. The controller device may intermediate between the application and the application server. The controller device may read the labels in the packet headers of the network traffic and slow down and/or speed up a rate of the traffic flow to and from the application server accordingly. Employing the controller device between the applications and the application server may effectively enable the application server to support the protocol without needing to upgrade the backend infrastructure of the application server.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1 is an example system.

FIG. 2 is an example system.

FIG. 3 is an example method.

FIG. 4 is an example method.

FIG. 5 is an example method.

FIG. 6 is an example computing device.

### DETAILED DESCRIPTION OF ILLUSTRATIVE EMBODIMENTS

Methods and systems for latency management are disclosed. In order to use a low-latency protocol, such as the L4S standard or DOCSIS Low Latency, a client device, such as an application executing on the client device, may mark a low-latency field, such as an explicit congestion notification (ECN) field, of a packet header with a label. The client device may mark the low-latency field of the packet header with a first label (e.g., ECT(1)) to indicate that the client device supports the low-latency protocol and is not experiencing network congestion. The client device may mark the low-latency field of the packet header with a second label (e.g., CE) to indicate that the client device supports the low-latency protocol and is experiencing network congestion.

If the client device marks the low-latency field of a packet header with either the first label or the second label, and the server supports the low-latency protocol (e.g., can read the first and second labels), the packet can be processed using a low-latency queue at a server. The server can transmit the packets in the low-latency queue to their respective destinations at a rate that is controlled by a scalable congestion control algorithm, such as transmission control protocol (TCP) Prague. The scalable congestion control algorithm may adapt the transmission rate based on network conditions.

However, the server may not support the low-latency protocol. The server may not be able read the first and second labels and/or may be unable to run the necessary scalable congestion control algorithm. It may be difficult, operationally disruptive, or costly to transition the servers to support the low-latency protocol, especially if the server is controlled or owned by a third-party cloud or hosting provider and/or if the server is associated with an operating system that does not support the low-latency protocol. As such, many existing applications cannot take advantage of the low-latency protocol, even though the quality of experience (QoE) for users of the application may benefit immensely from the low-latency protocol.

Described herein are techniques that enable applications to take advantage of the low-latency protocol even if the application server does not support the low-latency protocol. A controller device (e.g., computing device, border controller, proxy server device, broker device) may act as an intermediary between an application server, such as a legacy server that does not support the low-latency protocol, and an application that wants to utilize the low-latency protocol. The controller device may be operated as a cloud-based (e.g., remote network based) service on behalf of an application operator (e.g., need not be physically co-located with the application server). The controller device may slow down and/or speed up a rate of a packet flow in response to the label in the low-latency field of the packet header. If the controller device receives a packet from a client device that contains the second label in the low-latency field of the packet header to signal that the client device is experiencing network congestion, the controller device may reduce the rate at which traffic is sent to and/or from the server in order to be responsive to network congestion. If the client device switches from the second label to the first label to signal that the client device has stopped experiencing network congestion, the controller device may increase the rate at which traffic is sent to and/or from the server.

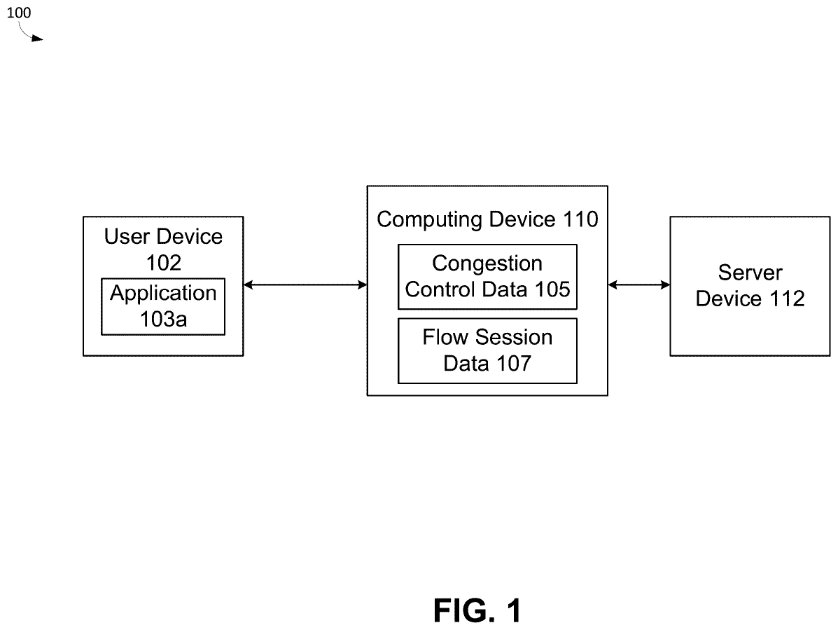

FIG. 1 shows a block diagram of an example system 100. The system 100 may comprise a user device 102, a computing device 110 (e.g., a controller device), and a server device 112. It should be noted that while the singular term device is used herein, it is contemplated that some devices may be implemented as a single device or a plurality of devices (e.g., via load balancing).

The user device 102 may comprise a computing device, a smart device (e.g., smart glasses, smart watch, smart phone), a mobile device, a tablet, a computing station, a laptop, a digital streaming device, a streaming stick, a television, a gateway device, a router device, a modem, and/or the like. The user device 102, the computing device 110, and the server device 112 may each be implemented as one or more computing devices. Any device disclosed herein may be implemented using one or more computing nodes, such as virtual machines, executed on a single device and/or multiple devices.

The server device 112 may be associated with (e.g., in communication with) an application 103. The application 103 may be executing (e.g., running) on the user device 102. The application 103 may comprise a gaming application, a live streaming application, a video streaming application, a video calling application, a navigation application, a real time communications application, a real-time analytics application, and/or any other type of application. The application 103 may support a low-latency protocol, such as the LAS standard or DOCSIS Low Latency. The application 103 and/or the user device 102 may insert one of a first label or a second label into first header data of at least one first packet. The application 103 may insert the first label or the second label into a low-latency field, such as an explicit congestion notification (ECN) field, of the first header data. The application 103 may use the application layer (e.g., layer 7) in the open systems interconnection (OSI) model to send and/or receive data.

The application 103 may insert the first label (e.g., ECT(1)) into the first header data to indicate that the application 103 and/or the user device 102 supports the low-latency protocol and that the application 103 and/or the user device 102 is not experiencing network congestion. The application 103 may insert the second label (e.g., CE) into the first header data to indicate that the application 103 and/or the user device 102 supports the low-latency protocol and that the application 103 and/or the user device 102 is experiencing network congestion. The insertion of the first and/or second labels may be performed at the application layer level. The application 103 and/or the user device 102 may send the at least one first packet comprising the first header data to the computing device 110 (e.g., via the application layer).

The computing device 110 may receive the at least one first packet from the application 103 and/or the user device 102. The computing device 110 may determine if the at least one first packet is associated with the low-latency protocol. To determine if the at least one first packet is associated with the low-latency protocol, the computing device 110 may examine the first header data. The computing device 110 may determine if the first header data comprises the first label or the second label. The computing device 110 may determine that the at least one first packet is associated with the low-latency protocol if the first header data comprises the first label or the second label. Conversely, the computing device 110 may determine that the at least one first packet is not associated with the low-latency protocol if the first header data does not comprise either the first label or the second label.

The computing device 110 may proxy a first flow (e.g., connection) between the application 103 (and/or the user device 102) and the server device 112. The first flow may be a temporary flow. The computing device 110 may proxy the first flow (e.g., connection) between the application 103 (and/or the user device 102) and the server device 112 based on (e.g., in response to) determining that the at least one first packet is associated with the low-latency protocol.

The computing device 110 may proxy the first flow (e.g., connection) between the application 103 (and/or the user device 102) and the server device 112 based on determining that at least one condition is satisfied. Determining that at least one condition is satisfied may comprise determining that a network address associated with the user device 102 satisfies at least one condition (e.g., matches a list or does not match a list). Determining that at least one condition is satisfied may comprise determining that a network address associated with a destination of the at least one packet satisfies at least one condition (e.g., matches a list or does not match a list). Determining that at least one condition is satisfied may comprise determining that an autonomous system number (ASN) satisfies at least one condition (e.g., matches a list or does not match a list). Determining that at least one condition is satisfied may comprise determining that a protocol (e.g., transport protocol, application protocol, and/or internet protocol version) associated with the user device 102 sending the at least one first packet to the computing device 110 satisfies at least one condition (e.g., matches a list or does not match a list). Determining that at least one condition is satisfied may comprise determining that a time, a date, or a day of the week satisfies at least one condition (e.g., matches a list or does not match a list). Determining that at least one condition is satisfied may comprise determining that a billing code or product code associated with the application 103 and/or the user device 102 satisfies at least one condition (e.g., matches a list or does not match a list).

The computing device 110 may determine if the server device 112 is associated with (e.g., supports, configured to use) the low-latency protocol. The computing device 110 may determine if the server device 112 is associated with (e.g., supports) the low-latency protocol based on the first flow. The computing device 110 may determine if the server device 112 is associated with (e.g., supports) the low-latency protocol based on packets received from the server device 112 via the first flow. The packets may be received by the computing device 110 from the server device 112. The packets may be addressed to the user device 102. If header data (e.g., the low-latency field of the header data) of the packets received from the server device 112 comprise the first label or the second label, the computing device 110 may determine that the server device 112 is associated with (e.g., supports) the low-latency protocol. If the computing device 110 determines that the server device 112 is associated with (e.g., supports) the low-latency protocol, the computing device 110 may terminate the first flow between the between the application 103 (and/or the user device 102) and the server device 112. If the computing device 110 terminates the first flow between the between the application 103 (and/or the user device 102) and the server device 112, traffic may flow directly between the application 103 (and/or the user device 102) and the server device 112 using the low-latency protocol.

Conversely, if header data (e.g., the low-latency field of the header data) of the packets received from the server device 112 does not comprise the first label or the second label, the computing device 110 may determine that the server device 112 is not associated with (e.g., does not support) the low-latency protocol. If the computing device 110 determines that the server device 112 is not associated with (e.g., does not support) the low-latency protocol, the computing device 110 may proxy (e.g., establish) a second flow (e.g., session, connection) between the application 103 (and/or the user device 102) and the server device 112.

The computing device 110 may log (e.g., store, record) flow session data 107 associated with the second flow between the application 103 (and/or the user device 102) and the server device 112. The computing device 110 may log the flow session data 107 associated with the connection between the application 103 (and/or the user device 102) and the server device 112 as a discrete user session. The flow session data 107 may comprise data indicating one or more of a start time associated with the second flow (e.g., 21:02:57 UTC on 1 Dec. 2023), an IP address of the user device 102, a type of the user device 102, one or more destination IP addresses (e.g., IP addresses that the user device 102 is sending packets to), an internet protocol version (e.g., v4 or v6), an ASN, a transport protocol (e.g., UDP, TCP, QUIC, etc.), an application protocol (e.g., QUIC, HTTP, DNS, SIP, DNS, web, voiceover, IP, video conferencing, gaming, etc.), a user type associated with the user device 102 (e.g., home, business, mobile, etc.), a software version associated with the application 103, and/or any other data associated with the application 103, the user device 102, the server device 112, and/or the connection.

If the computing device 110 determines that the first header data comprises the first label (e.g., ECT(1)), the computing device 110 may determine an increased rate at which to send the at least one first packet to the server device 112. The computing device 110 may determine an increased rate at which to send the at least one first packet to the server device 112 based on (e.g., using) at least one of a plurality of algorithms (e.g., congestion control algorithms and/or active queue management algorithms). The plurality of algorithms may be stored as algorithm data 105 by the computing device 110. Each of the plurality of algorithms may moderate the increased rate at which to send the at least one first packet to the server device 112 in a different manner. For example, a first algorithm may increase the sending rate exponentially. A second algorithm may increase the sending rate by doubling the sending rate. A third algorithm may increase the sending rate in steps. The algorithms may comprise, for example, a

Bottleneck Bandwidth and Round-trip propagation time (“BBR”) algorithm, a TCP Prague algorithm, a user datagram protocol (UDP) algorithm, a SQM (Smart Queue Management) algorithm, a controlled delay (“CoDel”) algorithm, a cake algorithm, a proportional integral controller enhanced (“PIE”) algorithm, and/or the like. The computing device 110 may send the at least one first packet to the server device 112 at the increased rate. The computing device 110 may send the at least one first packet to the server device 112 with the first header data.

Determining the increased rate at which to send the at least one first packet to the server device 112 may comprise determining at least one algorithm from the plurality of algorithms. The computing device 110 may determine at least one algorithm from the plurality of algorithm based on the algorithm data 105. The computing device 110 may determine the at least one algorithm based on a protocol associated with the user device 102 sending the at least one first packet to the computing device 110. The protocol associated with the user device 102 sending the at least one first packet to the computing device 110 may comprise a transport protocol (e.g., UDP, TCP, QUIC, etc.). If the protocol comprises a transport protocol, the computing device 110 may determine at least one algorithm associated with the transport protocol. For example, each of the plurality of algorithms may correspond to a particular transport protocol. The computing device 110 may select the algorithm that corresponds to the transport protocol associated with the user device 102 sending the at least one first packet to the computing device 110.

The protocol associated with the user device 102 sending the at least one first packet to the computing device 110 may comprise an application protocol (e.g., QUIC, HTTP, DNS, SIP, DNS, web, voiceover, IP, video conferencing, gaming, etc.). If the protocol comprises an application protocol, the computing device 110 may determine at least one algorithm associated with the application protocol. For example, each of the plurality of algorithms may correspond to a particular application protocol. The computing device 110 may select the algorithm that corresponds to the application protocol associated with the user device 102 sending the at least one first packet to the computing device 110. For example, HTTP traffic marked with the first label may be sped up at a slower rate than DNS traffic marked with the first label.

The computing device 110 may receive at least one packet from the server device 112. The at least one packet received from the server device may comprise header data. The at least one packet received from the server device may be addressed to the user device 102. The computing device 110 may send the at least one packet to the user device 102 based on the increased rate. The computing device 110 may determine that the header data of the at least one packet received from the server device does not comprise the first label. The computing device 110 may determine that the header data of the at least one packet received from the server device does not comprise the first label based on determining that the server device 112 removed the first label. If the computing device 110 determines that the header data of the at least one packet received from the server device does not comprise the first label, the computing device 110 may insert the first label into the header data, such as into an ECN field of the header data. The computing device 110 may send the at least one packet to the user device 102 with the first label inserted into the header data, such as at the increased rate.

If the network congestion begins to increase, the user device 102 and/or the application 103 may begin inserting the second label (e.g., CE) instead of the first label into packet header data. If the user device inserts the second label into packet header data, this may indicate that the user device 102 and/or the application 103 is experiencing network congestion. The application 103 and/or the user device 102 may send at least one second packet comprising second header data to the computing device 110. The second header data may comprise the second label (e.g., in an ECN field of the second header data).

The computing device 110 may receive the at least one second packet from the user device 102 and/or the application 103. If the computing device 110 determines that the second header data comprises the second label (e.g., CE), the computing device 110 may determine a decreased rate at which to send the at least one second packet to the server device 112. The computing device 110 may determine the decreased rate at which to send the at least one second packet to the server device 112 based on (e.g., using) at least one of a plurality of algorithms (e.g., congestion control algorithms and/or active queue management algorithms). Each of the plurality of algorithms may moderate the decreased rate at which to send the at least one second packet to the server device 112 in a different manner. For example, a first algorithm may decrease the sending rate exponentially. A second algorithm may decrease the sending rate by doubling the sending rate. A third algorithm may decrease the sending rate in steps. The algorithms may comprise, for example, a Bottleneck Bandwidth and Round-trip propagation time (“BBR”) algorithm, a TCP Prague algorithm, a user datagram protocol (UDP) algorithm, a SQM (Smart Queue Management) algorithm, a controlled delay (“CoDel”) algorithm, a cake algorithm, a proportional integral controller enhanced (“PIE”) algorithm, and/or the like. The computing device 110 may send the at least one second packet to the server device 112 at the decreased rate. The computing device 110 may send the at least one second packet to the server device 112 with the second header data.

Determining the decreased rate at which to send the at least one second packet to the server device 112 may comprise determining at least one algorithm from the plurality of algorithms. The computing device 110 may determine the at least one algorithm based on a protocol associated with the user device 102 sending the at least one second packet to the computing device 110. The protocol associated with the user device 102 sending the at least one second packet to the computing device 110 may comprise a transport protocol (e.g., UDP, TCP, QUIC, etc.). If the protocol comprises a transport protocol, the computing device 110 may determine at least one algorithm associated with the transport protocol. For example, each of the plurality of algorithms may correspond to a particular transport protocol. The computing device 110 may select the algorithm that corresponds to the transport protocol associated with the user device 102 sending the at least one second packet to the computing device 110.

The protocol associated with the user device 102 sending the at least one second packet to the computing device 110 may comprise an application protocol (e.g., QUIC, HTTP, DNS, SIP, DNS, web, voiceover, IP, video conferencing, gaming, etc.). If the protocol comprises an application protocol, the computing device 110 may determine at least one algorithm associated with the application protocol. For example, each of the plurality of algorithms may correspond to a particular application protocol. The computing device 110 may select the algorithm that corresponds to the application protocol associated with the user device 102 sending the at least one second packet to the computing device 110. For example, HTTP traffic marked with the second label may be slowed down at a quicker rate than DNS traffic marked with the second label.

The computing device 110 may receive at least one packet from the server device 112. The at least one packet received from the server device may comprise header data. The at least one packet received from the server device may be addressed to the user device 102. The computing device 110 may send the at least one packet to the user device 102 based on the decreased rate. The computing device 110 may determine that the header data of the at least one packet received from the server device does not comprise the second label. The computing device 110 may determine that the header data of the at least one packet received from the server device does not comprise the second label based on determining that the server device 112 removed the second label. If the computing device 110 determines that the header data of the at least one packet received from the server device does not comprise the second label, the computing device 110 may insert the second label into the header data, such as into an ECN field of the header data. The computing device 110 may send the at least one packet to the user device 102 with the second label inserted into the header data, such as at the decreased rate.

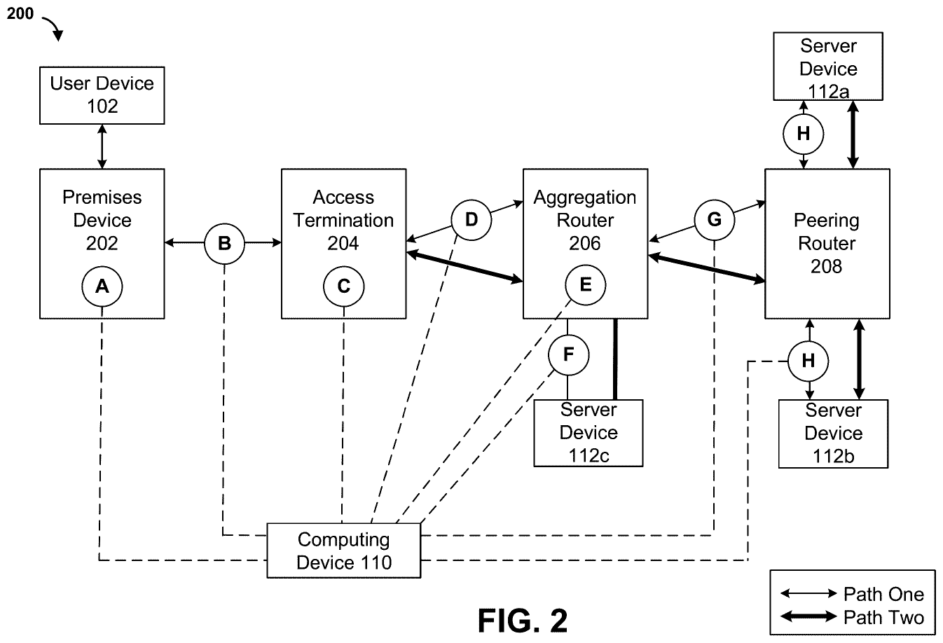

FIG. 2 is an example system 200. The system 200 may comprise the user device 102, the computing device 110, a premises device 202, a access termination device 204, a aggregation router device 206, a peering router device 208, and server devices 112a-c. One or more applications may be executing (e.g., running on) the user device 102. The server devices 112a-c may be associated with the application(s). As illustrated by the dashed lines, FIG. 2 shows various location options A-H for the computing device 110 within the system 200. The computing device 110 may be located at any combination of location options A-H, including being located at a single location of the options A-H or multiple locations of the options A-H. If the computing device 110 is responsive (e.g., operational), the components of the system 200 may communicate with each other via path one shown in FIG. 2. If the computing device 110 is not responsive (e.g., has crashed and/or experienced a failure), the components of the system 200 may communicate with each other via path two shown in FIG. 2.

The user device 102 may be in communication with (e.g., connected via a wireless or wired connection) the premises device 202. The premises device 202 may comprise a cable modem device, router device, or any network access customer premises equipment (CPE). The premises device 202 may be located at a premises. The user device 102 may be located at the premises. The computing device 110 may be positioned at location A (e.g., integrated into the premises device 202).

The premises device 202 may be in communication with (e.g., connected via a wireless or wired connection) the access termination device 204. The access termination device 204 may comprise a cable modem termination system (CMTS), a virtualized CMTS, a gateway device (e.g., a 5G radio access network (RAN) gateway device), a passive optical network (PON) optical line termination device, a low earth orbit (LEO) satellite device, a base station, and/or the like. The access termination device 204 may be located external to the premises. The computing device 110 may be positioned at location B (e.g., a separate in-line device installed between the premises device 202 and the access termination device 204). The computing device 110 may be positioned at location C (e.g., integrated into the access termination device 204).

The access termination device 204 may be in communication with (e.g., connected via a wireless or wired connection) the aggregation router device 206. The aggregation router device 206 may comprise a network aggregation router device, an upstream next hop router device, a cloud or centralized radio access network (C-RAN) packet aggregator, and/or the like. The aggregation router device 206 may be located external to the premises. The computing device 110 may be positioned at location D (e.g., a separate in-line device installed between the access termination device 204 and the aggregation router device 206). The computing device 110 may be positioned at location E (e.g., integrated into the aggregation router device 206).

The aggregation router device 206 may be in communication with (e.g., connected via a wireless or wired connection) the server device 112c. The computing device 110 may be positioned at location F (e.g., a separate in-line device installed between the aggregation router device 206 and the server device 112c). The aggregation router device 206 may be in communication with (e.g., connected via a wireless or wired connection) the peering router device 208. The peering router device 208 may comprise a border router, a virtualized border router, an edge server, and/or the like. The computing device 110 may be positioned at location G (e.g., a separate in-line device installed between the aggregation router device 206 and the peering router device 208). The peering router device 208 may be in communication with (e.g., connected via a wireless or wired connection) the server device 112a and the server device 112b. The computing device 110 may be positioned at location H (e.g., a separate in-line device installed between the aggregation router device 206 and the server device 112a and/or the server device 112b).

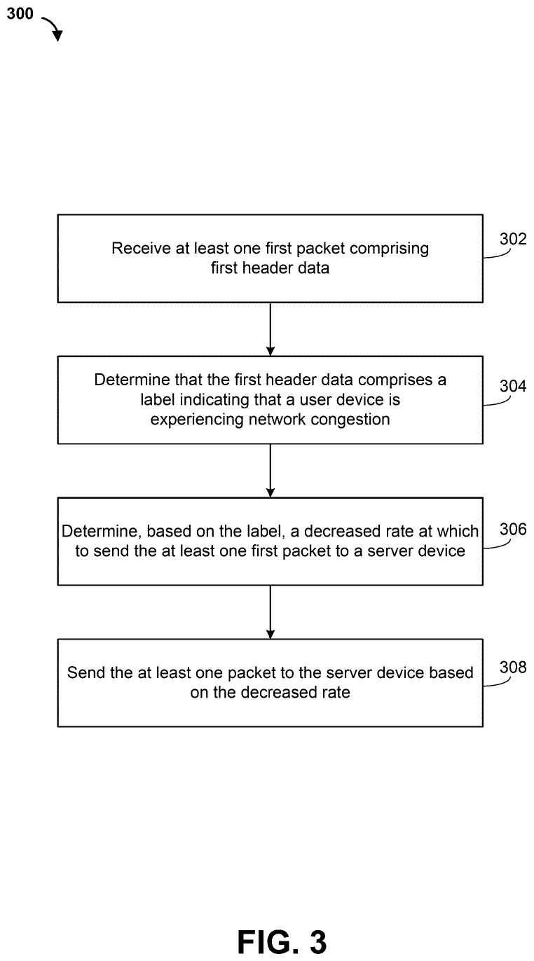

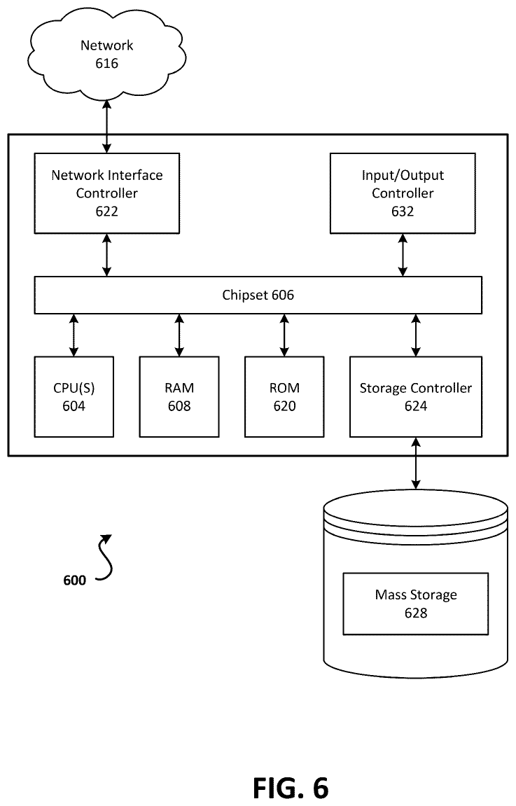

FIG. 3 is an example method 300. The method 300 may comprise a computer implemented method for latency management. A system and/or computing environment, such as the system 100 of FIG. 1 and/or the computing environment of FIG. 6, may be configured to perform the method 300. For example, the computing device 110 of FIG. 1 and/or FIG. 2 may be configured to perform the method 300.

At 302, at least one first packet may be received. The at least one first packet may comprise first header data. The at least one first packet may be received by a computing device, such as a controller device. The at least one first packet may be received from a user device, such as from an application executing on (e.g., running on) the user device. The at least one first packet may comprise first header data. The first header data may comprise a field, such as an ECN field, associated with a low latency protocol (e.g., congestion control protocol), such as the LAS protocol.

At 304, it may be determined that the first header data comprises a label. The label may indicate that the user device is experiencing network congestion. The label may comprise, for example, a CE label. The label may be comprised in (e.g., inserted into) the field associated with a low latency protocol (e.g., congestion control protocol). At 306, a decreased rate may be determined. The decreased rate may comprise a decreased rate at which to send the least one first packet to a server device. At 308, the at least one first packet may be sent to the server device. The at least one first packet may be sent to the server device at the decreased rate. The at least one first packet may be sent to the server device with the first header data, such as with the label in the first header data.

Determining the decreased rate may comprise determining at least one congestion control algorithm. Determining the at least one congestion control algorithm may comprise selecting the at least one congestion control algorithm from a plurality of algorithms. Each of the plurality of algorithms may moderate the decreased rate at which to send the at least one first packet to the server device in a different manner. The algorithms may comprise, for example, a Bottleneck Bandwidth and Round-trip propagation time (“BBR”) algorithm, a TCP Prague algorithm, a user datagram protocol (UDP) algorithm, a SQM (Smart Queue Management) algorithm, a controlled delay (“CoDel”) algorithm, a cake algorithm, a proportional integral controller enhanced (“PIE”) algorithm, and/or the like.

Determining the decreased rate at which to send the at least one first packet to the server device may be based on a protocol associated with the user device sending the at least one first packet (e.g., to the controller device). The at least one algorithm may be determined based on the protocol associated with the user device sending the at least one first packet (e.g., to the controller device). The protocol may comprise a transport protocol (e.g., UDP, TCP, QUIC, etc.) and/or an application protocol (e.g., QUIC, HTTP, DNS, SIP, DNS, web, voiceover, IP, video conferencing, gaming, etc.). Each of the plurality of algorithms may correspond to a particular protocol. Determining the at least one congestion control algorithm may comprise determining the at least one congestion control algorithm that corresponds to the protocol associated with the user device sending the at least one first packet (e.g., to the controller device). The decreased rate may be determined based on (e.g., using) the determined at least one congestion control algorithm.

If the user device stops experiencing congestion, at least one second packet comprising a second (e.g., different) label may be received. The at least one second packet may be received by the controller device. The at least one second packet may be received from the user device, such as from the application executing on (e.g., running on) the user device. The at least one second packet may comprise second header data. The second header data may comprise the field, such as the ECN field, associated with the low latency protocol (e.g., congestion control protocol), such as the L4S protocol. It may be determined that the second header data comprises the second label. The second label may indicate that the user device is no longer experiencing network congestion. The second label may comprise, for example, an ECT(1) label. The second label may be comprised in (e.g., inserted into) the field associated with the low latency protocol (e.g., congestion control protocol). If the at least one second packet is received, an increased rate may be determined (e.g., based on at least one at least one congestion control algorithm). The increased rate may comprise an increased rate at which to send the least one second packet to a server device. The at least one second packet may be sent to the server device at the increased rate.

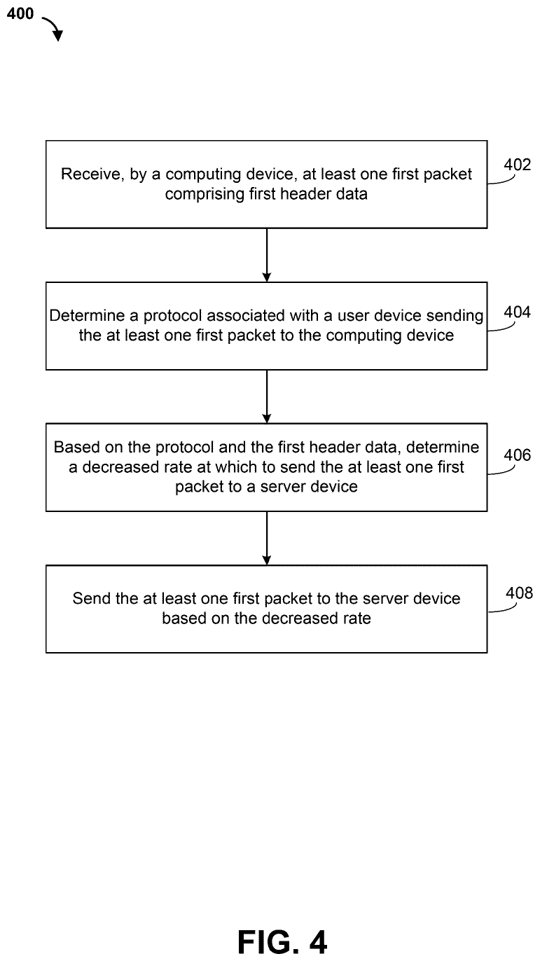

FIG. 4 is an example method 400. The method 400 may comprise a computer implemented method for latency management. A system and/or computing environment, such as the system 100 of FIG. 1 and/or the computing environment of FIG. 6, may be configured to perform the method 400. For example, the computing device 110 of FIG. 1 and/or FIG. 2 may be configured to perform the method 400.

At 402, at least one first packet may be received. The at least one first packet may comprise first header data. The at least one first packet may be received by a computing device, such as a controller device. The at least one first packet may be received from a user device, such as from an application executing on (e.g., running on) the user device. The at least one first packet may comprise first header data. The first header data may comprise a field, such as an ECN field, associated with a low latency protocol (e.g., congestion control protocol), such as the LAS protocol. The first header data may comprise a label. The label may indicate that the user device is experiencing network congestion. The label may comprise, for example, a CE label. The label may be comprised in (e.g., inserted into) the field associated with the low latency protocol (e.g., congestion control protocol).

At 404, a protocol may be determined. The protocol may be associated with the user device sending the at least one first packet (e.g., to the computing device). The protocol may comprise a transport protocol (e.g., UDP, TCP, QUIC, etc.) and/or an application protocol (e.g., QUIC, HTTP, DNS, SIP, DNS, web, voiceover, IP, video conferencing, gaming, etc.).

At 406, a decreased rate may be determined. The decreased rate may comprise a decreased rate at which to send the least one first packet to a server device. The decreased rate may be determined based on the protocol. Each of a plurality of congestion control algorithms may correspond to a particular protocol. Each of the plurality of congestion control algorithms may moderate the decreased rate at which to send the at least one first packet to the server device in a different manner. The algorithms may comprise, for example, a Bottleneck Bandwidth and Round-trip propagation time (“BBR”) algorithm, a TCP Prague algorithm, a user datagram protocol (UDP) algorithm, a SQM (Smart Queue Management) algorithm, a controlled delay (“CoDel”) algorithm, a cake algorithm, a proportional integral controller enhanced (“PIE”) algorithm, and/or the like. Determining the at least one congestion control algorithm may comprise determining the at least one congestion control algorithm that corresponds to the protocol associated with the user device sending the at least one first packet (e.g., to the computing device). The decreased rate may be determined based on (e.g., using) the determined at least one congestion control algorithm.

At 408, the at least one first packet may be sent to the server device. The at least one first packet may be sent to the server device based on the decreased rate. The at least one first packet may be sent to the server device with the first header data, such as with the label in the first header data.

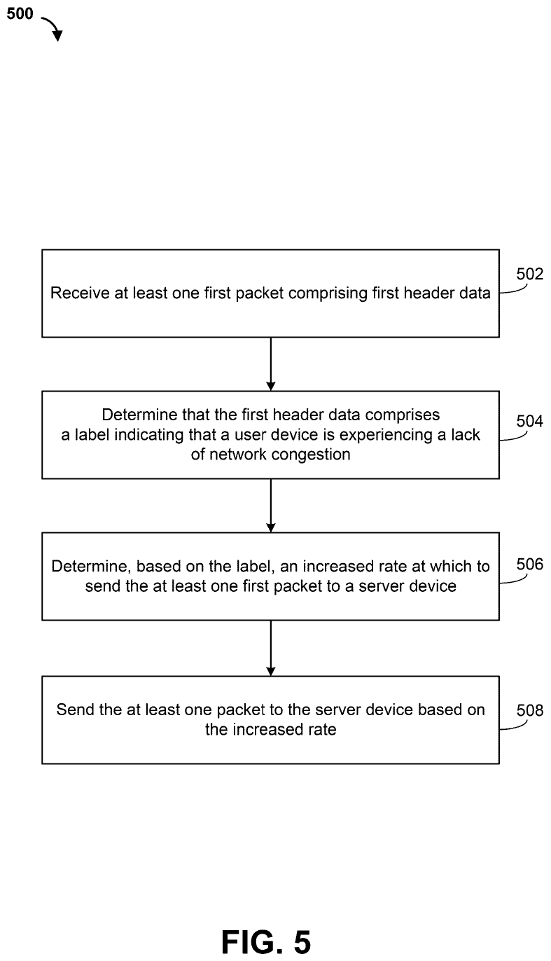

FIG. 5 is an example method 500. The method 500 may comprise a computer implemented method for latency management. A system and/or computing environment, such as the system 100 of FIG. 1 and/or the computing environment of FIG. 6, may be configured to perform the method 500. For example, the computing device 110 of FIG. 1 and/or FIG. 2 may be configured to perform the method 500.

At 502, at least one first packet may be received. The at least one first packet may comprise first header data. The at least one first packet may be received by a computing device, such as a controller device. The at least one first packet may be received from a user device, such as from an application executing on (e.g., running on) the user device. The at least one first packet may comprise first header data. The first header data may comprise a field, such as an ECN field, associated with a low latency protocol (e.g., congestion control protocol), such as the LAS protocol.

At 504, it may be determined that the first header data comprises a label. The label may indicate that the user device is not experiencing network congestion. The label may comprise, for example, an ECT(1) label. The label may be comprised in (e.g., inserted into) the field associated with a low latency protocol (e.g., congestion control protocol). At 506, an increased rate may be determined. The increased rate may comprise an increased rate at which to send the least one first packet to a server device. At 508, the at least one first packet may be sent to the server device. The at least one first packet may be sent to the server device at the increased rate. The at least one first packet may be sent to the server device with the first header data, such as with the label in the first header data.

Determining the decreased rate may comprise determining at least one congestion control algorithm. Determining the at least one congestion control algorithm may comprise selecting the at least one congestion control algorithm from a plurality of algorithms. Each of the plurality of algorithms may moderate the increased rate at which to send the at least one first packet to the server device in a different manner. The algorithms may comprise, for example, a Bottleneck Bandwidth and Round-trip propagation time (“BBR”) algorithm, a TCP Prague algorithm, a user datagram protocol (UDP) algorithm, a SQM (Smart Queue Management) algorithm, a controlled delay (“CoDel”) algorithm, a cake algorithm, a proportional integral controller enhanced (“PIE”) algorithm, and/or the like.

Determining the increased rate at which to send the at least one first packet to the server device may be based on a protocol associated with the user device sending the at least one first packet (e.g., to the computing device). The at least one algorithm may be determined based on the protocol associated with the user device sending the at least one first packet (e.g., to the computing device). The protocol may comprise a transport protocol (e.g., UDP, TCP, QUIC, etc.) and/or an application protocol (e.g., QUIC, HTTP, DNS, SIP, DNS, web, voiceover, IP, video conferencing, gaming, etc.). Each of the plurality of algorithms may correspond to a particular protocol. Determining the at least one congestion control algorithm may comprise determining the at least one congestion control algorithm that corresponds to the protocol associated with the user device sending the at least one first packet (e.g., to the computing device). The increased rate may be determined based on (e.g., using) the determined at least one congestion control algorithm.

If the user device starts experiencing congestion, at least one second packet comprising a second (e.g., different) label may be received. The at least one second packet may be received by the computing device. The at least one second packet may be received from the user device, such as from the application executing on (e.g., running on) the user device. The at least one second packet may comprise second header data. The second header data may comprise the field, such as the ECN field, associated with the low latency protocol (e.g., congestion control protocol), such as the L4S protocol. If may be determined that the second header data comprises the second label. The second label may indicate that the user device is experiencing network congestion. The second label may comprise, for example, a CE label. The second t label may be comprised in (e.g., inserted into) the field associated with the low latency protocol (e.g., congestion control protocol). If the at least one second packet is received, a decreased rate may be determined (e.g., based on at least one at least one congestion control algorithm). The decreased rate may comprise a decreased rate at which to send the least one second packet to a server device. The at least one second packet may be sent to the server device at the decreased rate.

FIG. 6 depicts a computing device that may be used in various aspects, such as the servers and/or devices depicted in FIG. 1. With regard to the example architecture of FIG. 1, any of the components or devices may each be implemented in an instance of a computing device 600 of FIG. 6.

The computer architecture shown in FIG. 6 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIGS. 3-5.

The computing device 600 may include a baseboard, or “motherboard,” which is a printed circuit board to which a multitude of components or devices may be connected by way of a system bus or other electrical communication paths. One or more central processing units (CPUs) 604 may operate in conjunction with a chipset 606. The CPU(s) 604 may be standard programmable processors that perform arithmetic and logical operations necessary for the operation of the computing device 600.

The CPU(s) 604 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like. The CPU(s) 604 may be augmented with or replaced by other processing units, such as GPU(s). The GPU(s) may comprise processing units specialized for but not necessarily limited to highly parallel computations, such as graphics and other visualization-related processing.

A chipset 606 may provide an interface between the CPU(s) 604 and the remainder of the components and devices on the baseboard. The chipset 606 may provide an interface to a random access memory (RAM) 608 used as the main memory in the computing device 600. The chipset 606 may further provide an interface to a computer-readable storage medium, such as a read-only memory (ROM) 620 or non-volatile RAM (NVRAM) (not shown), for storing basic routines that may help to start up the computing device 600 and to transfer information between the various components and devices. ROM 620 or NVRAM may also store other software components necessary for the operation of the computing device 600 in accordance with the aspects described herein.

The computing device 600 may operate in a networked environment using logical connections to remote computing nodes and computer systems through local area network (LAN) 616. The chipset 606 may include functionality for providing network connectivity through a network interface controller (NIC) 622, such as a gigabit Ethernet adapter. A NIC 622 may be capable of connecting the computing device 600 to other computing nodes over a network 616. It should be appreciated that multiple NICs 622 may be present in the computing device 600, connecting the computing device to other types of networks and remote computer systems.

The computing device 600 may be connected to a mass storage device 628 that provides non-volatile storage for the computer. The mass storage device 628 may store system programs, application programs, other program modules, and data, which have been described in greater detail herein. The mass storage device 628 may be connected to the computing device 600 through a storage controller 624 connected to the chipset 606. The mass storage device 628 may consist of one or more physical storage units. A storage controller 624 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 600 may store data on a mass storage device 628 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 628 is characterized as primary or secondary storage and the like.

For example, the computing device 600 may store information to the mass storage device 628 by issuing instructions through a storage controller 624 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 600 may further read information from the mass storage device 628 by detecting the physical states or characteristics of one or more particular locations within the physical storage units.

In addition to the mass storage device 628 described above, the computing device 600 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 600.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 628 depicted in FIG. 6, may store an operating system utilized to control the operation of the computing device 600. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 628 may store other system or application programs and data utilized by the computing device 600.

The mass storage device 628 or other computer-readable storage media may also be encoded with computer-executable instructions, which, when loaded into the computing device 600, transforms the computing device from a general-purpose computing system into a special-purpose computer capable of implementing the aspects described herein. These computer-executable instructions transform the computing device 600 by specifying how the CPU(s) 604 transition between states, as described above. The computing device 600 may have access to computer-readable storage media storing computer-executable instructions, which, when executed by the computing device 600, may perform the methods described in relation to FIGS. 6-11.

A computing device, such as the computing device 600 depicted in FIG. 6, may also include an input/output controller 632 for receiving and processing input from a number of input devices, such as a keyboard, a mouse, a touchpad, a touch screen, an electronic stylus, or other type of input device. Similarly, an input/output controller 632 may provide output to a display, such as a computer monitor, a flat-panel display, a digital projector, a printer, a plotter, or other type of output device. It will be appreciated that the computing device 600 may not include all of the components shown in FIG. 6, may include other components that are not explicitly shown in FIG. 6, or may utilize an architecture completely different than that shown in FIG. 6.

As described herein, a computing device may be a physical computing device, such as the computing device 600 of FIG. 6. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, or in addition, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method comprising:
receiving, by a computing device and from a user device, at least one first packet comprising first header data;
determining, by the computing device, that the first header data comprises a label indicating that the user device is experiencing network congestion;
determining, by the computing device and based on the label, a decreased rate at which to send the at least one first packet to a server device; and
sending the at least one first packet to the server device based on the decreased rate.

2. The method of claim 1, further comprising determining a protocol associated with the user device sending the at least one first packet to the computing device, wherein determining the decreased rate at which to send the at least one first packet to the server device is further based on the protocol.

3. The method of claim 2, wherein the protocol comprises at least one of a transport protocol or an application protocol.

4. The method of claim 1, further comprising:
receiving, from the server device, at least one second packet sent to the user device, wherein the at least one second packet comprises second header data;
determining that the second header data does not comprise the label; and
inserting the label into the second header data associated with the at least one second packet.

5. The method of claim 1, further comprising:
receiving, by the computing device and from the user device, at least one second packet comprising second header data;
determining that the second header data comprises a different label indicating that the user device is experiencing a lack of network congestion; and
determining, by the computing device and based on the different label, an increased rate at which to send the at least one second packet to the server device.

6. The method of claim 1, further comprising:
receiving, from the server device, at least one second packet sent to the user device; and
sending the at least one second packet to the user device based on the decreased rate.

7. The method of claim 1, wherein the first header data comprises a field associated with a congestion control protocol, wherein the label is comprised in the field.

8. The method of claim 7, further comprising determining that the server device does not support the congestion control protocol.

9. The method of claim 1, wherein determining the decreased rate at which to send the at least one first packet to the server device comprises:
determining at least one congestion control algorithm; and
determining the decreased rate based on the at least one congestion control algorithm.

10. The method of claim 1, wherein the label is inserted into the first header data by an application executing on the user device, and wherein the server device is associated with the application.

11. The method of claim 1, wherein determining the decreased rate at which to send the at least one first packet to the server device is based on at least one of:
a network address associated with the user device satisfying at least one condition;
an autonomous system number (ASN) satisfying at least one condition;
the protocol satisfying at least one condition;
a time or date satisfying at least one condition; or
a billing code or product code associated with the user device satisfying at least one condition.

12. A method comprising:
receiving, by a computing device and from a user device, at least one first packet comprising first header data;
determining a protocol associated with the user device sending the at least one first packet to the computing device;
based on the protocol and a label comprised in the first header data, determining a decreased rate at which to send the at least one first packet to a server device; and
sending the at least one first packet to the server device based on the decreased rate.

13. The method of claim 12, wherein determining the decreased rate at which to send the at least one first packet to the server device comprises:
determining at least one congestion control algorithm based on the protocol; and
determining the decreased rate based on the at least one congestion control algorithm.

14. The method of claim 12, wherein the protocol comprises at least one of a transport protocol or an application protocol.

15. The method of claim 12, further comprising:
receiving, from the server device, at least one second packet sent to the user device, wherein the at least one second packet comprises second header data;
determining that the second header data does not comprise the label; and
inserting the label into the second header data associated with the at least one second packet.

16. The method of claim 12, wherein the first header data comprises a field associated with a congestion control protocol that is not supported by the server device, and wherein the label is comprised in the field.

17. A method comprising:
receiving, by a computing device and from a user device, at least one first packet comprising first header data;
determining, by the computing device, that the first header data comprises a label indicating that the user device is experiencing a lack of network congestion;
determining, by the computing device and based on the label, an increased rate at which to send the at least one first packet to a server device; and
sending the at least one first packet to the server device based on the increased rate.

18. The method of claim 17, further comprising determining a protocol associated with the user device sending the at least one first packet to the computing device, wherein determining the increased rate at which to send the at least one first packet to the server device is further based on the protocol.

19. The method of claim 17, further comprising:
receiving, from the server device, at least one second packet sent to the user device, wherein the at least one second packet comprises second header data;
determining that the second header data does not comprise the label; and
inserting the label into the second header data associated with the at least one second packet.

20. The method of claim 17, wherein the first header data comprises a field associated with a congestion control protocol that is not supported by the server device, and wherein the label is comprised in the field.
